(19) United States
(12) Patent Application Publication
(10) Pub. No.: US 2014/0360775 A1
(43) Pub. Date: Dec. 11, 2014

(54) CABLE PROTECTIVE BUSHING FOR TERMINAL DISPLAY STAND

(71) Applicant: Kum Oh Electronics CO., LTD., Bucheon-si (KR)

(72) Inventor: Ki Sang KIM, Siheung-si (KR)

(21) Appl. No.: 13/910,393

(22) Filed: Jun. 5, 2013

(51) Int. Cl. G08B 13/14; H02G 3/22

(52) U.S. Cl. CPC G08B 13/1445; H02G 3/22
USPC 174/650

(57) ABSTRACT

Disclosed herein is a cable protective bushing for a terminal display stand which is configured such that an antitheft cable connected to a terminal can be prevented from being damaged by being scraped on a corner or an edge of the display stand while the cable is repeatedly extracted from the display stand and retracted thereinto. The cable protective bushing includes an insert part which is disposed in a cable hole formed in the terminal display stand so that a cable passes through the cable hole, and a rounded extension part which extends from a lower end of the insert part and is disposed in the terminal display stand and rounded with respect to a vertical direction, thus preventing the cable from being damaged when the cable is extracted from the cable hole or retracted thereinto.

### BACKGROUND OF THE INVENTION

1. Field of the Invention

The present invention relates to a cable protective bushing for a terminal display stand which is provided to display terminals and, more particularly, to a cable protective bushing which is configured such that an antitheft cable connected to a terminal can be prevented from being damaged by being scraped on a corner or an edge of the display stand while the cable is repeatedly extracted from the display stand and retracted thereinto.

2. Description of the Related Art

Generally, different kinds of electronic products (hereinafter, referred to as ‘terminals’) such as cellular phones, navigation devices, cameras, etc. are displayed on display stands for marketing or sales of such products. Recently, terminals are becoming increasingly expensive and include many high-tech functions.

As these terminals become more expensive, the risk of theft increases. In an effort to overcome the above problem, antitheft techniques were proposed by the applicant of the present invention in Korean Patent Registration No. 1196832, entitled “Antitheft device for camera”, Korean Patent Registration No. 1263930, entitled “Antitheft device for camera”. In the above conventional techniques, a terminal is connected to an alarm device by a cable. When an attempt is made to steal the terminal, for example, when the cable is separated from the terminal or is cut, the alarm device makes a warning sound as the above event is determined to be a theft event.

### SUMMARY OF THE INVENTION

Accordingly, the present invention has been made keeping in mind the above problems occurring in the prior art, and an object of the present invention is to provide a cable protective bushing for a terminal display stand which is configured such that an antitheft cable connecting an alarm device to a terminal that is displayed on the display stand for marketing or selling can be prevented from being damaged while the cable is repeatedly extracted from the display stand and retracted thereinto.

In order to accomplish the above object, the present invention provides a cable protective bushing for a terminal display stand, including: an insert part disposed in a cable hole formed in the terminal display stand so that a cable passes through the cable hole; and a rounded extension part extending from a lower end of the insert part, the rounded extension part being disposed in the terminal display stand and rounded with respect to a vertical direction, thus preventing the cable from being damaged when the cable is extracted from the cable hole or retracted thereinto.

Preferably, a stopper may protrude outwards from an upper end of the insert part so that the insert part is stopped by the stopper on a portion of the terminal display stand that defines the cable hole

The rounded extension part may be rounded with respect to a horizontal direction to cover the cable, thus preventing the cable from being displaced from a correct position thereof when the cable is extracted from the cable hole or retracted thereinto.

The insert part may have an opening slot so that a diameter thereof can be reduced by an external force.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a display stand provided with a cable protective bushing, according to an embodiment of the present invention;

FIG. 2 illustrates the cable protective bushing according to the present invention; and

FIG. 3 is of sectional views illustrating a risk of occurrence of damage to a cable depending on whether the cable protective bushing according to the present invention is used or not.

### DESCRIPTION OF THE PREFERRED EMBODIMENTS

Hereinafter, a cable protective bushing for a terminal display stand according to the present invention will be described in detail with reference to the attached drawings.

This invention may, however, be embodied in many different forms, and should not be construed as limited to the embodiments set forth herein. Rather, all changes that fall within the bounds of the present invention, or the equivalence of the bounds are therefore intended to be embraced by the present invention.

The same reference numerals throughout the drawings, that is, the same reference numerals for the second digit or the first digit, or for the second digit, the first digit and a letter of the alphabet, denote elements having the same function. If not specifically mentioned otherwise, the elements denoted by the reference numerals are to be assumed to comply with the above-mentioned reference scheme.

In the drawings, the thicknesses of lines or the sizes of elements may be exaggerated or simplified to more clearly and conveniently illustrate the present invention, but the bounds of the present invention must not be interpreted as being limited thereto.

The terminology used herein is for the purpose of describing particular embodiments only and is not intended to be limiting. As used herein, the singular forms “a,” “an” and “the” are intended to include plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

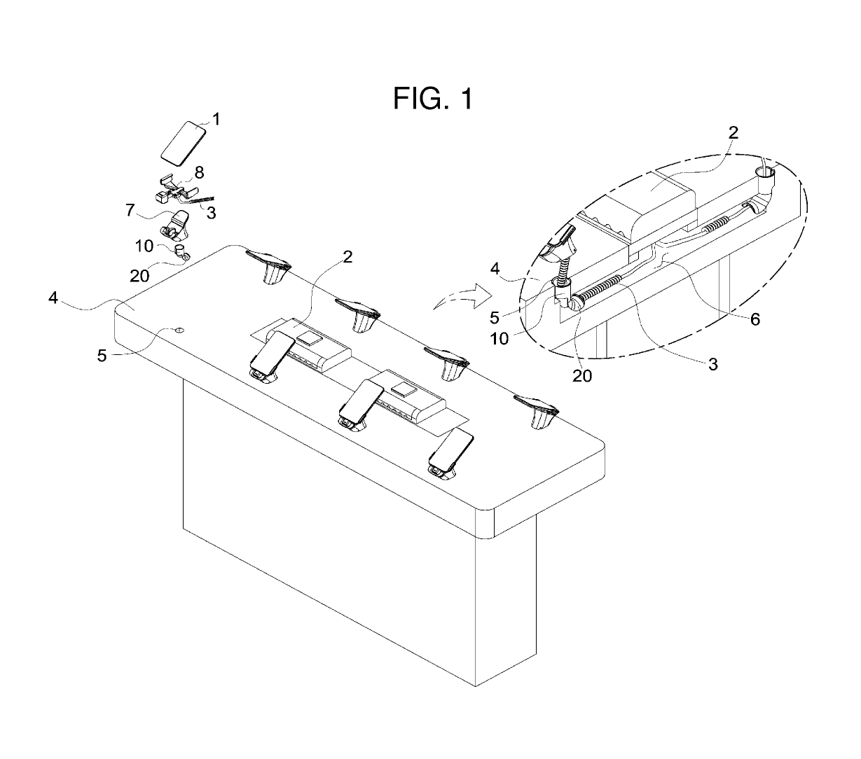

FIG. 1 illustrates an example of a display stand provided with an alarm device for preventing terminals from being stolen, which was proposed by the applicant of the present invention.

Mounts which support terminals thereon are provided at predetermined positions on the display stand. The alarm device which makes a warning sound when there is a theft attempt is provided on a central portion of the display stand.

If the cables, which connect the terminals to the alarm devices, are exposed to the outside, the appearance of the display stand deteriorates, thus reducing a display appearance and marketing effect. Therefore, the cables which connect the terminals to the alarm device are disposed in the internal space of the display stand so that the cables are usually prevented from being exposed to the outside and, when a seller lifts a terminal to introduce it to a consumer or the consumer lifts a terminal to observe it, the corresponding cable is extracted from the display stand.

Each cable has a sufficient length to which it can be extracted from the display stand, and then retracted again thereinto. Preferably, a curl cable having appropriate elasticity is used as the cable so that the cable that has been extracted from the display stand can be automatically retracted into the display stand when the terminal is placed on the corresponding mount without requiring for the seller or consumer to retract the cable into the display stand.

The display stand has a space which can receive the cables therein. Cable holes are formed in the display stand at positions at which the mounts are disposed, so that the cables can pass through the corresponding cable holes.

The cable holes are perpendicular to the display stand internal space. Thus, an angled corner is formed on a lower end of each cable hole.

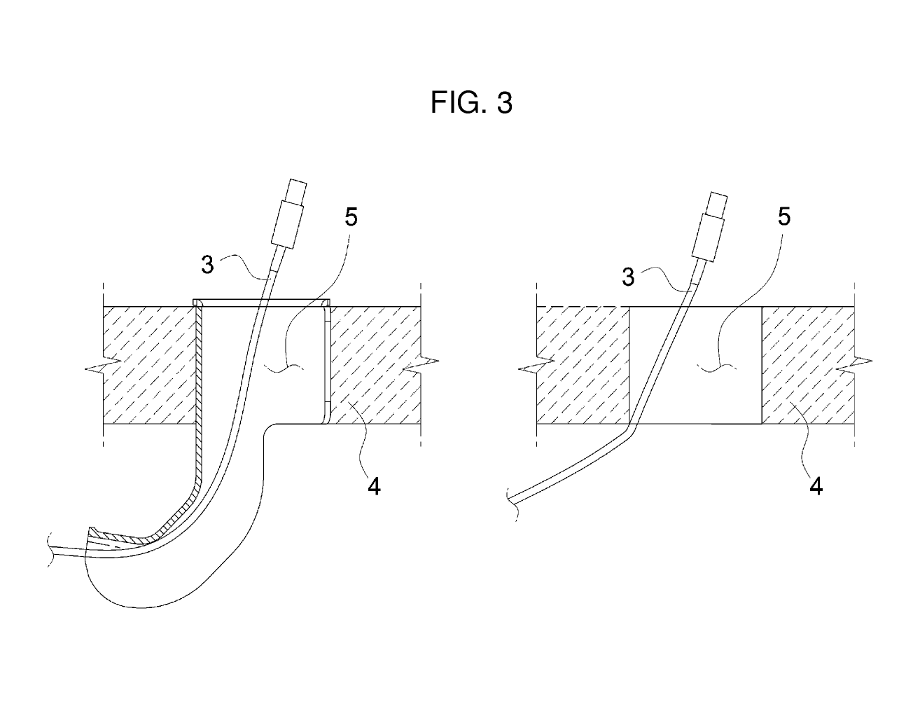

Hence, as shown in the right view of FIG. 3, the cable 3 which passes through the cable hole 5 makes contact with the corner. When the cable 3 is repeatedly extracted from or retracted into the display stand, the cable 3 scrapes on the corner, in a manner in which it may be damaged. For example, a sheath of the cable 3 may peel off, or an inner wire may be broken.

FIG. 1 illustrates terminals 1, which are displayed on the terminal display stand, for example, smartphones which are being recently widely distributed and are being used as daily necessities in advanced countries.

Each smartphone 1 is locked by a locking device 8 which was proposed in Korean Patent Application No. 10-2013-0028652, entitled “Grip type terminal locking device”, filed by the applicant of the present invention, so that an unauthorized person is prevented from accessing a communication port of the smartphone 1 or removing the smartphone 1 from the display stand. The smartphone 1 locked to the locking device 8 is placed on a mount 7 so that it may be displayed.

If a smartphone 1 is forcibly removed from the corresponding locking device 8, or a cable 3 which connects the locking device 1 to an alarm device 2 is cut off, for example, if an unauthorized person makes an attempt to steal the smartphone 1, the alarm device 2 makes a warning sound.

As shown in FIG. 1, the cable protective bushing according to the present invention is inserted into a cable hole 5 which is formed in each of the portions of the display stand 4, where the respective mounts 7 are located on the display stand 4, so that the corresponding cable 3 passes through the cable hole 5.

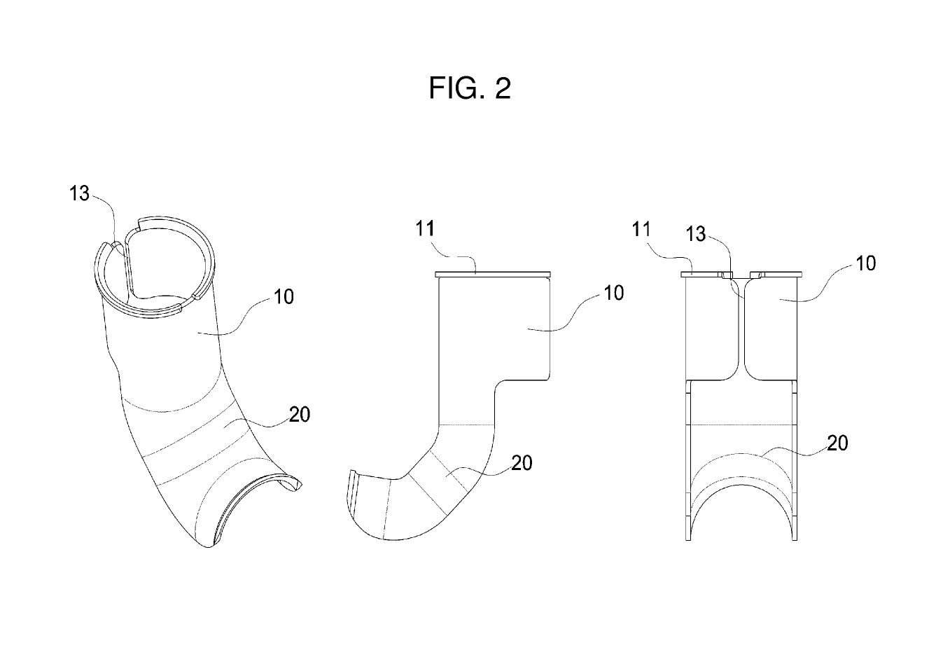

As shown in FIG. 2, the cable protective bushing according to the present invention includes an insert part 10 and a rounded extension part 20.

The insert part 10 has a cylindrical shape and is supported by the display stand 4 in such a way that an outer surface of the insert part 10 makes contact with an inner surface of the cable hole 5 of the display stand 4. A stopper 11 extends outwards from an upper end of the insert part 10 so that the insert part 10 is stopped by the stopper 11 on the portion of the display stand 4 that defines the cable hole 5. An opening slot 13 is vertically formed in the insert part 10 so that when external force is applied to the insert part 10, for example, when a user pushes the insert part 10 using his/her hand, the diameter thereof can be reduced, whereby the insert part 10 can be easily inserted into the cable hole 5. Also, the insert part 10 has appropriate elasticity so that, when external force is eliminated therefrom, it can return to its original position.

The rounded extension part 20 is integrally extended downwards from a lower end of the insert part 10 and is rounded with respect to a vertical direction to cover a corner of the display stand 4 that is formed between the cable hole 5 and an internal space 6 of the display stand 4. The cable 3 passes through the rounded extension part 20.

Furthermore, the rounded extension part 10 is rounded with respect to the horizontal direction to cover the cable 3, whereby the cable 3 can be prevented from being displaced from its original position when it is extracted from the display stand or retracted thereinto.

As shown in the left view of FIG. 3, the rounded extension part 10 is connected to the insert part 10 in such a way as to have a smoothly rounded structure without having an angulated portion, thus minimizing friction between the cable 3 and the cable protective bushing when the cable 3 is inserted thereinto, thereby preventing the cable 3 from suffering damage, such as scratches, tears, general wear etc.

The cable protective bushing according to the present invention is configured such that the insert part 10 and the rounded extension part 20 are integrated with each other and is made of a material such as metal or synthetic resin. In the case where the cable protective bushing is made of metal, it can be formed by pressing, and in the case of the bushing made of synthetic resin, it can be formed by injection molding.

As described above, in a cable protective bushing for a terminal display stand according to the present invention, a rounded extension part facilitates extraction of a cable from a cable hole or retraction of the cable therefrom and reduces friction resulting from contact, thus preventing the cable from being damaged, for example, worn, scratched, torn, etc. Furthermore, the rounded extension part covers the cable so that, during the process of extracting the cable from the bushing or retracting it thereinto, the cable can be prevented from being undesirably displaced from the bushing. An insert part is configured such that the diameter thereof can be elastically reduced, whereby the insert part provided with a stopper can be simply inserted into the cable hole of the display stand and reliably maintained in the installed state. Therefore, the present invention is very useful in industrial development.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A cable protective bushing for a terminal display stand, comprising:
an insert part disposed in a cable hole formed in the terminal display stand so that a cable passes through the cable hole; and
a rounded extension part extending from a lower end of the insert part, the rounded extension part being disposed in the terminal display stand and rounded with respect to a vertical direction, thus preventing the cable from being damaged when the cable is extracted from the cable hole or retracted thereinto.

2. The cable protective bushing as set forth in claim 1, wherein a stopper protrudes outwards from an upper end of the insert part so that the insert part is stopped by the stopper on a portion of the terminal display stand that defines the cable hole

3. The cable protective bushing as set forth in claim 1, wherein the rounded extension part is rounded with respect to a horizontal direction to cover the cable, thus preventing the cable from being displaced from a correct position thereof when the cable is extracted from the cable hole or retracted thereinto.

4. The cable protective bushing as set forth in claims 1, wherein the insert part has an opening slot so that a diameter thereof can be reduced by an external force.

5. The cable protective bushing as set forth in claims 2, wherein the insert part has an opening slot so that a diameter thereof can be reduced by an external force.

6. The cable protective bushing as set forth in claims 3, wherein the insert part has an opening slot so that a diameter thereof can be reduced by an external force.
